(19) United States
(12) Patent Application Publication
(10) Pub. No.: US 2014/0236452 A1
(43) Pub. Date: Aug. 21, 2014

(54) METHOD FOR OPERATING AN INTERNAL COMBUSTION ENGINE

(71) Applicants: Wolfgang Fischer, Gerlingen (DE); Silke Seuling, Remseck/Neckar (DE); Joachim Paul, Stuttgart (DE); Roberto Saracino, Melendugno (LE) (IT); Sebastian-Paul Wenzel, Eisenach (DE)

(72) Inventors: Wolfgang Fischer, Gerlingen (DE); Silke Seuling, Remseck/Neckar (DE); Joachim Paul, Stuttgart (DE); Roberto Saracino, Melendugno (LE) (IT); Sebastian-Paul Wenzel, Eisenach (DE)

(21) Appl. No.: 14/131,158

(22) PCT Filed: Jun. 26, 2012
(86) PCT No.: PCT/EP2012/062310

§ 371 Date: Apr. 9, 2014

(30) Foreign Application Priority Data
Jul. 4, 2011 (DE) 10 2011 078 609.0

(51) Int. Cl. F02D 29/00

(52) U.S. Cl. CPC F02D 29/00
USPC 701/101

(57) ABSTRACT

A method for operating an internal combustion engine is described. A base controlled variable for influencing an actual value of an operating variable of the internal combustion engine is ascertained. The actual value of the operating variable is compared to a setpoint value of the operating variable. A correcting variable is ascertained as a function of the comparison. A controlled variable is ascertained as a function of the base controlled variable and as a function of the correcting variable. An actual value of a state variable of the internal combustion engine is ascertained. A start point in time of a time interval of a critical state change of the internal combustion engine is ascertained as a function of the ascertained actual value of the state variable. The controlled variable is essentially ascertained from an intermediate controlled variable and a correcting variable following the start point in time.

### FIELD OF THE INVENTION

The present invention relates to a method for operating an internal combustion engine.

### BACKGROUND INFORMATION

It is known to ascertain a correcting variable as a function of an operating variable of an internal combustion engine, which is, for example, obtained through sensor signals, and as a function of a comparison of an actual value and a setpoint value of the operating variable. The correcting variable is combined with an associated controlled variable to adapt the controlled variable to the actual operating conditions represented by the actual value of the operating variable.

It is also known that rapid changes of a state of the internal combustion engine may result, for example, in a higher noise level, an increase in harmful substances, an unstable torque, or generally in an unstable operation of the internal combustion engine.

A method for controlling and/or regulating an internal combustion engine is known from German Published Patent Appln. No. 10 2006 001 374 A1. In the method, a regulator adjusts a combustion position variable characterizing a combustion position to a setpoint value. A controller and/or a regulator influence(s) a torque variable characterizing the torque of the internal combustion engine and/or a noise variable characterizing the noise of the internal combustion engine with the aid of a controlled variable.

A method for controlling an internal combustion engine is known from German Published Patent Appln. No. 10 2004 046 086 A1. Based on the comparison of a variable which characterizes the combustion process in at least one cylinder, a deviation value is ascertained for this variable. Based on the deviation value, a first manipulated variable of a first final control element is adapted for influencing the activation start. Based on the first manipulated variable, a second manipulated variable of a second final control element is adapted for influencing the air mass.

### SUMMARY

By taking into account a state variable of the internal combustion engine, a critical state change of the internal combustion engine is recognized. By ascertaining the controlled variable as a function of an intermediate controlled variable and the correcting variable following a start point in time of the critical state change, the curve of the controlled variable may be advantageously adapted to the critical state change.

In addition to avoiding the previously stated disadvantages, the method according to the present invention may significantly reduce a dating and calibration complexity of a control unit for an internal combustion engine, since especially the previously stated critical state changes do not have to be taken into account any longer when assigning functions. In particular, the method according to the present invention results in a simplification of the functions in the control unit. For example, present regulators may be simplified and therefore require less computing and storing capacity.

In one particularly advantageous specific embodiment of the present invention, a controlled variable is essentially ascertained from a previously stored fixed value of a base controlled variable and a correcting variable. The start of the critical state change therefore does not result in an immediate change of the controlled variable, but the controlled variable only changes as a function of the change of the correcting variable. In this way, it is advantageously prevented that an operating state of the internal combustion engine is reached which, for example, results in an unstable torque, a loud combustion, or an increase in the harmful substances. Damage to the internal combustion engine may also be advantageously prevented in this way. Particularly advantageously, this specific embodiment of the method hardly needs any computing time or storing resources and is at the same time very effective in stabilizing dynamic states of the internal combustion engine.

In one alternative specific embodiment, the intermediate controlled variable is ascertained on the basis of the base controlled variable following the start point in time in such a way that the slope of the intermediate controlled variable is limited by a maximum value.

In one advantageous specific embodiment, the controlled variable is essentially ascertained prior to a start point in time and following an end point in time of the critical state change from the base controlled variable, in particular an actual value of the base controlled variable, and the correcting variable. In this way, the control and regulating methods suitable previously may advantageously be used or continued during normal operation, i.e., prior to and following a critical state change including normal state transitions or quasi-stationary states.

In one advantageous specific embodiment of the method, the controlled variable is ascertained following the end point in time as a function of a slope of the curve of the controlled variable prior to and/or in the area of the end point in time. Unsteady and non-differentiable transitions in the area of the end point in time are advantageously prevented in this way.

In another advantageous specific embodiment of the method, a difference is formed from the actual value of the state variable and a setpoint value of the state variable, and the critical state change is recognized when the formed difference exceeds a threshold value. As a result, the critical state change is easily advantageously recognized.

Other features, possible applications, and advantages of the present invention are derived from the following description of exemplary embodiments of the present invention, which are illustrated in the figures of the drawing. All features described or illustrated represent the object of the present invention alone or in any arbitrary combination, regardless of their is recapitulation in the patent claims or their back-references, and regardless of their wording in the description or illustration in the drawing. The same reference numerals are used for functionally equivalent variables in all figures, even in different specific embodiments.

### BRIEF DESCRIPTION OF THE DRAWINGS

FIG. 1 shows a schematic block diagram for ascertaining a controlled variable.

FIG. 2 shows a schematic block diagram for ascertaining a critical state change.

FIG. 3 shows a schematic time diagram having a chronological curve of the controlled variable and other chronological curves.

### DETAILED DESCRIPTION

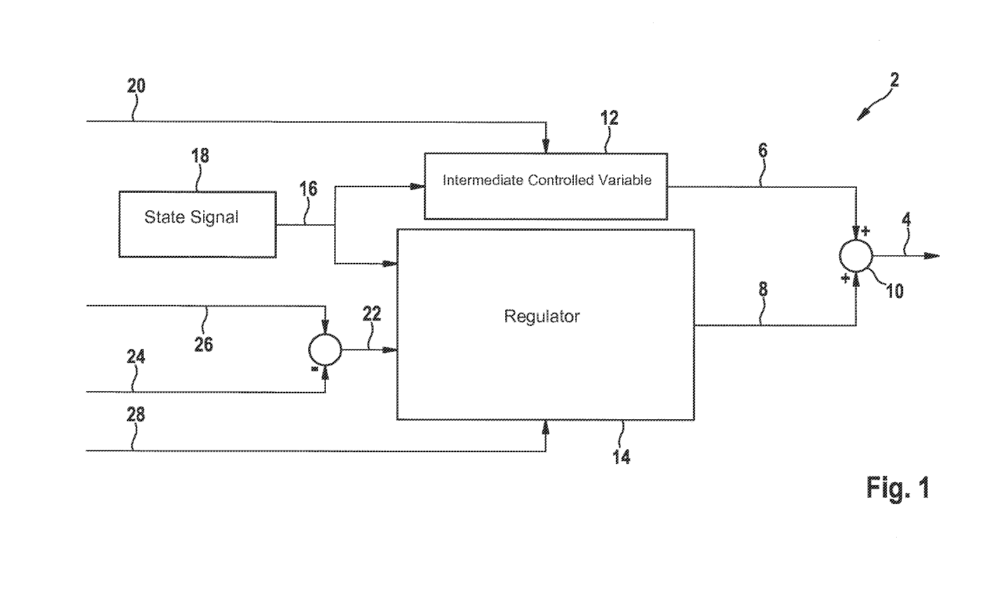

FIG. 1 shows a schematic block diagram 2 for ascertaining a controlled variable 4. Controlled variable 4 is in particular an injection duration, an injection start point in time, an injection end point in time, a fuel injection quantity, a position of the throttle valve, or a position of the exhaust gas recirculation valve.

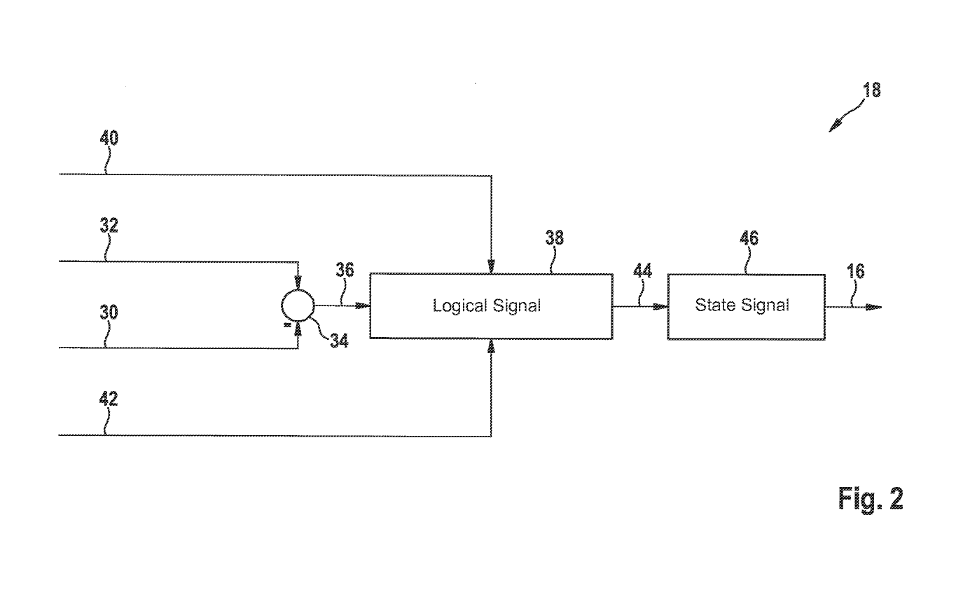

Block diagram 2 represents a function or functions which may be carried out on a control unit (not shown) of an internal combustion engine, in particular of a motor vehicle. Controlled variable 4 is ascertained from an intermediate controlled variable 6 and a correcting variable 8. At one point 10, controlled variable 4 results by adding intermediate controlled variable 6 and correcting variable 8. Intermediate controlled variable 6 is generated by a block 12. Correcting variable 8 is generated by a regulator 14. A state signal 16 is generated by a block 18 for state ascertainment and supplied to block 12 and regulator 14. State signal 16 is preferably a logical signal. Block 18 is explained in greater detail in FIG. 2.

A base controlled variable 20 is supplied to block 12. Base controlled variable 20 is ascertained, for example, from a characteristic map, an assigning diagram and/or other items of the control unit such as another regulator. Controlled variable 4 is ascertained as a function of base controlled variable 20 and as a function of correcting variable 8.

A system deviation 22 is supplied to regulator 14. System deviation 22 results by subtracting an actual value 24 of an operating variable of the internal combustion engine from a setpoint value 26 of the operating variable of the internal combustion engine. Actual value 24 of the operating variable is thus compared to setpoint value 26 of the operating variable. Correcting is variable 8 is ascertained as a function of this comparison, i.e., system deviation 22. In the form, not shown, actual value 24 and setpoint value 26 of the operating variable may also be supplied directly to regulator 14. Base controlled variable 20 influences actual value 24 of the operating variable via feedback when base controlled variable 20 corresponds to intermediate controlled variable 6 or at least influences it. The ascertainment of correcting variable 8 is used to correct base controlled variable 20 with regard to a desired setpoint value 26 of the operating variable. Furthermore, minimum and/or maximum limiting values 28 which delimit the value range of correcting variable 8 or a slope of the correcting variable are supplied to regulator 14.

The operating variable is, for example, a quality of the fuel combustion, a noise-indicating variable for the fuel combustion, or a torque-indicating variable. Actual value 24 of the operating variable is, for example, ascertained based on a sensor signal being emitted by a sensor, e.g., a torque sensor. Alternatively, actual value 24 of the operating variable may also originate from a characteristic map or a function of the control unit.

If the operating variable is a quality of the fuel combustion, a center of the combustion is used for this purpose, for example. The center of the combustion corresponds to an engine position, e.g., a certain crankshaft angle, in which essentially half of the entire combustion heat has already been released or in which essentially half of the fuel quantity is already combusted. Alternatively, the operating variable may also represent a start of the fuel injection in the form of quality of the fuel combustion, essentially 5% of the entire combustion heat being released, for example, or essentially 5% of the fuel quantity already being combusted. As the start of the fuel injection, a point in time may be assumed at which a cylinder internal pressure in a cylinder departs from a predefined pressure characteristic.

If the operating variable is a noise-indicating variable for the fuel combustion, this variable displays, for example, a high noise level when a maximum pressure gradient is exceeded by the gradient of the cylinder internal pressure. Other methods may also be used which ascertain a sound pressure level in decibels from available values of the internal combustion engine.

If the operating variable is a torque-indicating variable, this variable may, for example, be an ascertained work per working stroke or else an indicated medium pressure. The indicated medium pressure is a measure for the performance output of the internal combustion engine and results, for example, from a chronological mean value of the cylinder internal pressure during a working stroke, reduced by a chronological mean value of the cylinder internal pressure during a compression stroke.

Controlled variable 4 is supplied to a final control element in a manner not shown, the final control element (not shown) ascertaining a manipulated variable which is supplied to a controlled system. The final control element is designed as a part of the control unit which allows the parameters of the internal combustion engine to be influenced which influence the operating variable. In particular, these parameters are boundary conditions which influence the operating variable. If controlled variable 4 is, for example, a time target for the fuel injection, the final control element of the control unit determines when the fuel injection starts and ends, the final control element including a corresponding part of the control unit and the activation electronic system which transmits via a line the manipulated variable ascertained as a function of controlled variable 4 to an injector. The controlled system essentially includes in this case the injector, the cylinder, and all involved components of the internal combustion engine. The controlled system generates a controlled variable which corresponds to the operating variable and is supplied to a measuring element. In general, the controlled system includes all components of the internal combustion engine which have an influence on the generated controlled variable, parts of the control unit also possibly being part of the controlled system. With the aid of the measuring element, pressure characteristics of the cylinder internal pressure are, for example, made available to the control unit, this being implemented, for example, via a corresponding pressure sensor in the cylinder, a corresponding cable connection, and signal formers such as amplifiers, filters, and analog/digital converters. The measuring element ascertains actual value 24 as a function of the controlled variable.

FIG. 2 shows a schematic block diagram of block 18 from FIG. 1 for ascertaining a critical state change. Block 18 is used for generating state signal 16 which is preferably logical. For this purpose, an actual value 30 of a state variable of the internal combustion engine is combined and compared with a setpoint value 32 of the state variable at one point 34. In particular, a difference 36 is formed with the aid of a difference formation at point 34 from actual value 30 and setpoint value 32. Setpoint value 32 may, for example, be generated by a characteristic map which is acted on by other parameters of the internal combustion engine.

Actual value 30 of the state variable may also be ascertained by evaluating a corresponding sensor signal originating from a corresponding sensor, e.g., a pressure sensor for the fuel pressure, or alternatively or additionally starting from another function of the control unit. In particular, the state variable is an exhaust gas recirculation rate, a fresh air mass, a charging pressure, an injection time, a fuel pressure, a fuel quantity, or an operating mode.

In one exemplary specific embodiment, the state variable is an exhaust gas recirculation rate, the operating variable is the center of the combustion, and the controlled variable corresponds to a time target of a main injection, e.g., of the injection start, the injection end and/or the injection duration.

In another exemplary specific embodiment, the state variable is a charging pressure in an intake system of the internal combustion engine, the operating variable is the gradient of the cylinder internal pressure, and the controlled variable corresponds to a time target of a pilot injection, e.g., of the injection start, the injection end and/or the injection duration. In this sense, other not elucidated combinations of state variable, operating variable, and controlled variable are conceivable.

Difference 36 is supplied to a block 38. Furthermore, an upper threshold value 40 and a lower threshold value 42 are supplied to block 38. Block 38 generates a logical signal 44. Now, if difference 36 exceeds upper threshold value 40 or falls below lower threshold value 42, signal 44 displays a critical state change, in particular value logical “1.” If difference 36 is between upper threshold value 40 and lower threshold value 42, signal 44 does not display a critical state change, i.e., a normal operation of the internal combustion engine, in particular logical “0.” Logical signal 44 is supplied to a block 46 for debouncing. Block 46 generates state signal 16 as a function of logical signal 44. The debouncing in block 46 means, for example, that briefly exceeding upper threshold value 40 or falling below lower threshold value 42 due to difference 36, visible through a brief logical “1” of signal 44, does not result in a logical “1” of state signal 16.

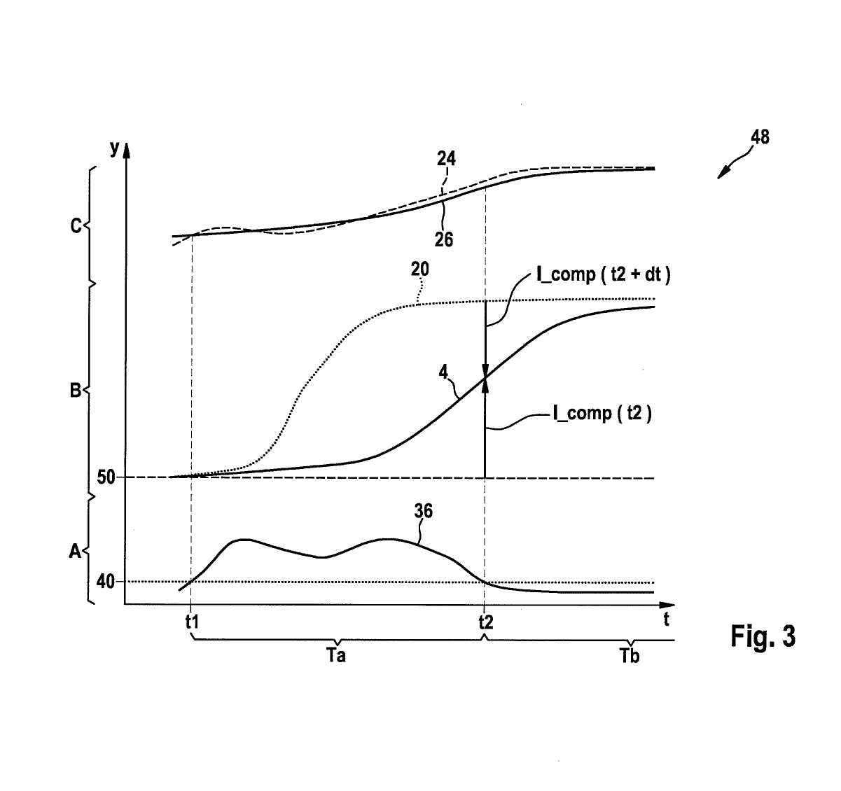

FIG. 3 shows a schematic time diagram 48 having an exemplary chronological curve of controlled variable 4 and other exemplary chronological curves. A start point in time t1 as well as an end point in time t2 of a time interval Ta of the critical state change of the internal combustion engine are plotted along a time axis t. End point in time t2 is another start point in time of another time interval Tb having no critical state change. Another axis y extends orthogonally to time axis t, different variables having different measures in each case being plotted in areas A, B, and C.

An exemplary curve of difference 36 from FIG. 2 is shown in area A. Furthermore, upper threshold value 40 is plotted. The curve of difference 36 exceeds upper threshold value 40 at start point in time t1. The curve of difference 36 stays above upper threshold value 40 between start point in time t1 and end point in time t2. The curve of difference 36 falls below upper threshold value 40 at end point in time t2. The curve of difference 36 stays below upper threshold value 40 starting from end point in time t2. Accordingly, start point in time t1 of time interval Ta of the critical state change of the internal combustion engine is ascertained as a function of ascertained actual value 30 of the state variable. Likewise, end point in time t2 of time interval Ta of the critical state change is ascertained as a function of actual value 30 of the state variable. State signal 16 from FIGS. 1 and 2 shows the critical state change during time interval Ta as a logical “1.” Prior to start point in time t1 and following end point in time t2, the internal combustion engine is no longer in the critical state change, but in normal operation.

Area C shows an exemplary curve of actual value 24 and an exemplary curve of setpoint value 26 of the operating variable of the internal combustion engine. Both curves have a rising progression, setpoint value 26 being below actual value 24 in the vicinity of end point in time t2. Although in the case of the embodiment of the operating variable as a parameter for the indicated mean pressure, the curve of actual value 24 of the parameter for the actual indicated mean pressure moves above setpoint value 26 of the parameter for the desired indicated mean pressure in the area of end point in time t2, this distance remains small. This small distance between actual value 24 and setpoint value 26 is achieved by the described method.

Area B shows the exemplary curve of controlled variable 4. Prior to start point in time t1, controlled variable 4 is essentially formed from base controlled variable 20 and correcting variable 8. Prior to start point in time t1, state signal 16 equals logical “0” and block 12 from FIG. 1 relays in this normal operation base controlled variable 20 directly to point 10 as an intermediate controlled variable 6. During the transition from normal operation of the internal combustion engine to the operation having the critical state change of the internal combustion engine, i.e., having a transition of state signal 16 from logical “0” to logical “1,” block 12 ascertains a fixed value 50 of base controlled variable 4 as an actual value of base controlled variable 20 ascertained last prior to start point in time t1. In the area of start point in time t1, fixed value 50 of base controlled variable 20 is thus ascertained and stored.

The shown curve of base controlled variable 20 is essentially always above the curve of controlled variable 4 within time interval Ta. In particular, the curve of controlled variable 4 has a smaller slope than the curve of base controlled variable 20. Due to the nature of controlled variable 4 in time interval Ta, controlled variable 4 proceeds less abruptly than base controlled variable 20.

Following start point in time t1, controlled variable 4 is essentially ascertained from stored fixed value 50 of base controlled variable 20 and correcting variable 8. Due to the fact that in the area of start point in time t1 fixed value 50 is stored and starting from or following point in time t1 controlled variable 4 is ascertained on the basis of fixed value 50 as well as correcting variable 8, the result is a constant and differentiable transition of the curve of controlled variable 4 from normal operation to the operation having the critical state change. However, the change of controlled variable 4 now only depends on the change of correcting variable 8.

Alternatively, block 12 generates intermediate controlled variable 6 on the basis of base controlled variable 20 following start point in time t1 during time interval Ta in such a way that the slope of intermediate controlled variable 6 is limited by a maximum value.

Following end point in time t2, controlled variable 4 is essentially formed from base controlled variable 20 and correcting variable 8. At end point in time t2, it is switched from the operation having the critical state change to normal operation, i.e., state signal 16 transitions from its logical state “1” to logical state “0.” Block 12 now relays the actual value of base controlled variable 20 as intermediate controlled variable 6, intermediate controlled variable 6 thus corresponding to base controlled variable 20. At end point in time t2, regulator 14 receives the information with the aid of the transition from logical “1” to logical “0” that correcting variable 8 is now computed on the basis of the actual value of base controlled variable 20. Regulator 14 may be designed as a proportional integral regulator, for example. Controlled variable 4 is in this case ascertained according to formula 1 as a Final_Sg_val, Pre_corr_Sg_val corresponding to intermediate controlled variable 6 and Gov_Corr_val corresponding to correcting variable 8. Intermediate controlled variable 6, i.e., Pre_corr_Sg_val, corresponds to fixed value 50 during time interval Ta.

Final_{—}Sg_{—}val=Pre_corr_{—}Sg_{—}val+Gov_Corr_{—}val (1)

Correcting variable 8 is ascertained according to formula 2, correcting variable 8, as Gov_Corr_val, being formed by adding a proportional portion P_comp and an integral portion I_comp. Parameter t describes the dependence on the time.

Gov_Corr_{—}val(t)=P_comp(t)+I_comp(t) (2)

Proportional portion P_comp results from formula 3, P_par being a proportional parameter, Des_Bt_val being setpoint value 26 of the operating variable, and Act_Bt_val being actual value 24 of the operating variable.

P_comp(t)=P_{—}par·(Des_{—}Bt_{—}val(t)−Act_{—}Bt_{—}val(t)) (3)

Integral portion I_comp results from formula 4, I_par being an integral parameter.

$$I\_comp ( t ) = I\_par \cdot {\int }_{0}^{t} ( Des\_Bt \_val ( t ) - Act\_Bt \_cal ( t ) ) d t \qquad ( 4 )$$

When carrying out the method, regulator 14 stores the curve of system deviation 22 up to point t within integral portion I_comp(t). If end point in time t2 is reached, intermediate controlled variable 6 goes back to being base controlled variable 20. In order to avoid sudden changes in the curve of controlled variable 4, integral portion I_comp(t) is overwritten by another integral portion I_comp(t2+dt) at another point in time t2+dt, i.e., directly following point in time t2. At point in time t2, controlled variable 4 results as Final_Sg_val according to formula 5.

Final_{—}Sg_{—}val(t2)=Pre_corr_{—}Sg_{—}val(t2)+Gov_Corr_{—}val(t2) (5)

Correcting variable 8 as Gov_Corr_val results according to formula 6, I_comp(t2) being illustrated in FIG. 3. Analogously, integral portion I_comp(t2) results according to formula 4 for end point in time t2.

Gov_Corr_{—}val(t2)=P_comp(t2)+I_comp(t2) (6)

Intermediate controlled variable 6, i.e., Pre_corr_Sg_val, corresponds during time interval Ta to fixed value 50 and starting from other point in time t2+dt, i.e., during time interval Tb, it corresponds to base controlled variable 20. For other point in time t2+dt, i.e., directly following point in time t2, integral portion I_comp(t2+dt) results according to formula 7 by subtracting base controlled variable 20 as intermediate controlled variable 6, i.e., Pre_corr_Sg_val(t2+dt), from controlled variable 4 at end point in time t2, i.e., Final_Sg_val(t2).

I_comp(t2+dt)=Final_{—}Sg_{—}val(t2)−Pre_corr_{—}Sg_{—}val(t2+dt) (7)

Since proportional portion P_comp is essentially the same at point in time t2 and at other point in time t2+dt and I_comp is ascertained at other point in time t2+dt according to formula 7 and the old value is overwritten, the result is controlled variable 4 at end point in time t2, i.e., Final_Sg_Val(t2), essentially corresponding to controlled variable 4 at other point in time t2+dt, i.e., Final-Sg_val(t2+dt), and thus no sudden change being present in the curve of controlled variable 4.

If a variable is mentioned in this text, in particular with regard to an ascertainment, a processing, or the like, it is always to be understood to mean the actual value of the corresponding variable. If a value of a variable determined over time is meant, in particular with reference to time, this is stated explicitly. If a variable is to reach a certain value, this is to be explicitly understood as an actual value and a setpoint value of the variable.

The above-described methods may be carried out as a computer program for a digital arithmetic unit. The digital arithmetic unit is suitable to carry out the above-described methods as a computer program. The internal combustion engine is in particular provided for a motor vehicle and includes a control unit which includes the digital arithmetic unit, in particular a microprocessor. The control unit includes a storage medium on which the computer program is stored.

1-14. (canceled)

15. A method for operating an internal combustion engine, comprising:
ascertaining a base controlled variable for influencing an actual value of an operating variable of the internal combustion engine;
comparing the actual value of the operating variable to a setpoint value of the operating variable;
ascertaining a correcting variable as a function of the comparing;
ascertaining a controlled variable as a function of the base controlled variable and as a function of the correcting variable;
ascertaining an actual value of a state variable of the internal combustion engine; and
ascertaining a start point in time of a time interval of a critical state change of the internal combustion engine as a function of the ascertained actual value of the state variable, wherein the controlled variable is ascertained from an intermediate controlled variable and a correcting variable following the start point in time.

16. The method as recited in claim 15, wherein in an area of the start point in time, a fixed value of the base controlled variable is ascertained and stored, and the intermediate controlled variable is the stored fixed value.

17. The method as recited in claim 15, wherein the intermediate controlled variable is ascertained on the basis of the base controlled variable following the start point in time in such a way that a slope of the intermediate controlled variable is limited by a maximum value.

18. The method as recited in claim 15, wherein an end point in time of the time interval of the critical state change is ascertained as a function of the actual value of the state variable.

19. The method as recited in claim 18, wherein the controlled variable is formed from the base controlled variable and the correcting variable prior to the start point in time and following the end point in time.

20. The method as recited in claim 19, wherein the controlled variable is ascertained directly following the end point in time as a function of an integral portion, and the integral portion results by subtracting the base controlled variable as the intermediate controlled variable from the controlled variable by the end point in time.

21. The method as recited in claim 15, further comprising:
forming a difference from the actual value of the state variable and a setpoint value of the state variable, wherein the start point in time of the critical state change is recognized when the formed difference exceeds a threshold value.

22. The method as recited in claim 16, wherein the fixed value of the base controlled variable is ascertained as an actual value of the base controlled variable ascertained last prior to the start point in time.

23. The method as recited in claim 15, wherein the state variable is one of an exhaust gas recirculation rate, a fresh air mass, a charging pressure, an injection duration, a fuel pressure, a fuel quantity, and an operating mode.

24. The method as recited in claim 15, wherein the operating variable is one of a quality of a fuel combustion, a noise-indicating variable, and a torque-indicating variable.

25. The method as recited in claim 15, wherein the base controlled variable and the controlled variable are one of an injection duration, an injection start point in time, an injection end point in time, a fuel injection quantity, a position of a throttle valve, and a position of a exhaust gas recirculation valve.

26. A computer program for a digital arithmetic unit which is suitable to carry out a method for operating an internal combustion engine, comprising:
ascertaining a base controlled variable for influencing an actual value of an operating variable of the internal combustion engine;
comparing the actual value of the operating variable to a setpoint value of the operating variable;
ascertaining a correcting variable as a function of the comparing;
ascertaining a controlled variable as a function of the base controlled variable and as a function of the correcting variable;
ascertaining an actual value of a state variable of the internal combustion engine; and
ascertaining a start point in time of a time interval of a critical state change of the internal combustion engine as a function of the ascertained actual value of the state variable, wherein the controlled variable is ascertained from an intermediate controlled variable and a correcting variable following the start point in time.

27. A control unit for an internal combustion engine, comprising:
a digital arithmetic unit on which a computer program is executable, the computer program being suitable to carry out a method for operating an internal combustion engine, comprising:
ascertaining a base controlled variable for influencing an actual value of an operating variable of the internal combustion engine;
comparing the actual value of the operating variable to a setpoint value of the operating variable;
ascertaining a correcting variable as a function of the comparing;
ascertaining a controlled variable as a function of the base controlled variable and as a function of the correcting variable;
ascertaining an actual value of a state variable of the internal combustion engine; and
ascertaining a start point in time of a time interval of a critical state change of the internal combustion engine as a function of the ascertained actual value of the state variable, wherein the controlled variable is ascertained from an intermediate controlled variable and a correcting variable following the start point in time.

28. The control unit as recited in claim 27, wherein the control unit is for a motor vehicle.

29. The control unit as recited in claim 27, wherein the control unit includes a microprocessor.

30. A storage medium for a control unit of an internal combustion engine, on which a computer program is stored, the computer program being for a digital arithmetic unit which is suitable to carry out a method for operating the internal combustion engine, the method comprising:
ascertaining a base controlled variable for influencing an actual value of an operating variable of the internal combustion engine;
comparing the actual value of the operating variable to a setpoint value of the operating variable;
ascertaining a correcting variable as a function of the comparing;
ascertaining a controlled variable as a function of the base controlled variable and as a function of the correcting variable;
ascertaining an actual value of a state variable of the internal combustion engine; and
ascertaining a start point in time of a time interval of a critical state change of the internal combustion engine as a function of the ascertained actual value of the state variable, wherein the controlled variable is ascertained from an intermediate controlled variable and a correcting variable following the start point in time.

31. The storage medium as recited in claim 30, wherein the control unit is for a motor vehicle.
